(19) United States
(12) Patent Application Publication
(10) Pub. No.: US 2026/0056122 A1
(43) Pub. Date: Feb. 26, 2026

(54) SYSTEMS AND METHODS FOR DETECTING SINGLE-MOLECULE BINDING KINETICS

(71) Applicant: ARIZONA BOARD OF REGENTS ON BEHALF OF ARIZONA STATE UNIVERSITY, Scottsdale, AZ (US)

(72) Inventors: Shaopeng Wang, Chandler, AZ (US); Xiaoyan Zhou, Tempe, AZ (US)

(73) Assignee: ARIZONA BOARD OF REGENTS ON BEHALF OF ARIZONA STATE UNIVERSITY, Scottsdale, AZ (US)

(21) Appl. No.: 19/286,703

(22) Filed: Jul. 31, 2025

Related U.S. Application Data
(60) Provisional application No. 63/685,012, filed on Aug. 20, 2024.

(51) Int. Cl. G01N 21/47

(52) U.S. Cl. CPC G01N 21/4738

(57) ABSTRACT

Provided herein are methods of detecting single-molecule binding kinetics that include contacting a set of single molecules with a surface of an optically transparent substrate and irradiating the surface of the substrate with light having an incident angle selected to achieve total reflection of the light. In some embodiments, the methods include collecting light scattered by the surface and by the subset of the single molecules having the binding association with the surface of the substrate to form a series of raw image data sets, and detecting multiple individual binding and leaving events for the subset of the single molecules having the binding association with the surface of the substrate over one or more selected durations using the series of raw image data sets to produce a detected individual binding and leaving event data set. Systems, computer readable media, and additional methods are also provided.

### CROSS-REFERENCE TO RELATED APPLICATIONS

This application claims the benefit of, U.S. Provisional Patent Application Ser. No. 63/685,012, filed Aug. 20, 2024, the disclosure of which is incorporated herein by reference in its entirety.

### TECHNICAL FIELD

This invention relates to evanescent scattering imaging of single molecules.

### BACKGROUND

Single-molecule detections push beyond ensemble averages and reveal the statistical distributions of molecular sizes and binding processes. Fluorescence microscopy is firstly developed and has been widely used for this purpose by shifting the detection wavelength from excitation wavelength to dramatically reduce the background for improving the signal-to-noise ratio, thus allowing single molecule imaging. Besides, the gold nanoparticles and chain polymers can also be used to increase the light-analyte interaction cross section for single molecule detection. In contrast with above-mentioned label involved techniques, the label-free single molecule detection has been developed in the past two decades for analyzing the intrinsic molecular properties, such as size and mass, along with monitoring the molecular interaction process without labels. Evanescent illumination is usually employed for label-free single molecule detection, because it can enhance light-analyte interaction and reduce background by notably reducing the illumination volume. However, specific optical structures, such as microspheres and nanomaterials, are generally needed to efficiently couple the incident light into the evanescent field. Until now, it is still challenging to employ these exquisite microspheres and nanomaterials for wide-field single-molecule imaging applications, such as parallelly monitoring the dynamic molecular binding process in different locations. Recently developed plasmonic scattering microscopy (PSM) utilizes the surface plasmonic wave propagating along the surface of the gold-coated glass slide as evanescent illumination, which notably simplified the system structure. But the plasmon field generates much heat at high incident light power, limiting its applications for detecting temperature sensitive biological molecules as well as long-term monitoring of molecular interaction processes.

Accordingly, there is a need for additional techniques for single molecule detection and analysis.

### SUMMARY

Molecular interactions are fundamental to various biological processes such as cell signaling, enzyme activity, protein function, and disease development. Understanding the kinetics of these interactions is important for providing detailed quantitative and mechanistic insights, which are vital for advancements in life sciences and biomedical research. Traditional methods often produce averaged results from large populations of molecules, thereby obscuring the unique behaviors and complexities of individual molecular interactions and normally need separate steps to measure association and dissociation kinetics. To overcome these limitations, among other attributes, in some embodiments, the present disclosure introduces one-step molecular interaction kinetic measurement methods, based on label-free real-time optical imaging of the binding and leaving events of individual analyte molecules on a sensor surface. By leveraging kinetics-based information, these methods distinguish specific from nonspecific bindings and accurately determine association and dissociation rates in a single step. These techniques are particularly effective for studying weak or complex interactions, as they record and analyze each interaction at the single-molecule level, offering a significant improvement over conventional approach. These and other attributes will be apparent based on a complete review of the present disclosure, including the accompanying figures.

As described herein, multiplexed single molecule detection and imaging can be realized on a plain glass surface by imaging the interference between the evanescent scattering light from the single molecules and from the natural roughness of the cover glass. This allows quantification of the mass of single proteins, characterization of the protein-antibody interactions at single molecule level, and analysis of the heterogeneity of single molecule binding behaviors. The diffusion properties of linker anchored single molecules can also be quantified by tracking their nanoscale motions. Thus, label-free single molecule detection and functional analysis with ordinary consumables for precise detection of small biological complexes is disclosed.

Evanescent scattering microscopy (ESM) and plasmonic scattering microscopy (PSM) share similar optical detection configurations and both use total internal reflected light to illuminate the sample and substrate, there are significant differences between the two methods. In particular, ESM does not require a substrate with a metal coating layer, and can use any wavelength of light, including ultraviolet, visible, and infrared (e.g., 10 nm to 350 μm). ESM can detect scattered light from a sample and from the top surface (opposite side of incident light) or bottom surface (same side as incident light) of a substrate contacted by the sample. In contrast, it is difficult to collect scattered light from a bottom surface of the substrate in PSM at least because the metal layer reflects and absorbs the scattered light. One advantage of detecting the scattered light from a bottom surface of the substrate is having an open top surface to facilitate sample delivery and manipulation, as well as for integration with other technologies (e.g., electrical/impedance measurement, or path clamp measurement).

In one aspect, the present disclosure provides a method of detecting single-molecule binding kinetics. The method includes contacting a set of single molecules with a surface of an optically transparent substrate, and irradiating the surface of the substrate with light having an incident angle selected to achieve total reflection of the light, thereby scattering light from the surface and from at least a subset of the single molecules having a binding association with the surface of the substrate. The method also includes collecting light scattered by the surface and by the subset of the single molecules having the binding association with the surface of the substrate to form a series of raw image data sets, and detecting multiple individual binding and leaving events for the subset of the single molecules having the binding association with the surface of the substrate over one or more selected durations using the series of raw image data sets to produce a detected individual binding and leaving event data set, thereby detecting the single-molecule binding kinetics.

Various optional features of the above embodiments include the following. Determining one or more single molecule binding durations by pairing dynamic information in the detected individual binding and leaving event data set. Determining at least one association rate (kₐ) and at least one dissociation rate (k_{d}) using the detected individual binding and leaving event data set. Identifying specific binding events and non-specific binding events in the detected individual binding and leaving event data set. Filtering identified non-specific binding events from the detected individual binding and leaving event data set. Determining at least one association rate (kₐ) and at least one dissociation rate (k_{d}), and identifying specific binding events and non-specific binding events using the detected individual binding and leaving event data set in a single step. Applying at least one data processing protocol to the series of raw image data sets to produce processed image data sets, which data processing protocol is configured to: remove noise from the series of raw image data sets; magnify one or more morphological characteristics of the single molecules in the series of raw image data sets; select one or more candidate pixels if an intensity level of a given candidate pixel in the series of raw image data sets exceeds a threshold intensity level to provide one or more sets of selected candidate pixels; extract location and intensity information for the single molecules in one or more selected regions that comprise the selected candidate pixels to provide a set of location and intensity information; and/or, identify the multiple individual binding and leaving events using the set of location and intensity information. The single molecules comprise proteins. The proteins are bound to a first surface with carboxylic groups. An intensity of the image is proportional to a molecular weight of the single molecules. The method further comprises assessing binding kinetics of the single molecules to the first surface over time. The light has a wavelength between 10 nm and 400 nm, between 200 nm and 400 nm, between 400 nm and 700 nm, between 700 nm and 1100 nm, or between 700 nm to 350 μm. The method further comprises assessing association and dissociation properties of the single molecules with respect to the first surface by digitally counting a number of the single molecules bound to the first surface over time.

Various additional optional features of the above embodiments include the following. Removing the noise by row averaging and normalizing the series of raw image data sets. Applying a Haar-like array to magnify the one or more morphological characteristics of the single molecules in the series of raw image data sets. Fitting a two-dimensional (2D) model to the one or more selected regions that comprise the selected candidate pixels to extract the set of location and intensity information. Deleting given candidate pixels in the sets of selected candidate pixels when the given candidate pixels have a bias level that exceeds a predetermined bias threshold level in fitting from at least one Gaussian blob. The intensity level comprises a plasmonic scattering microscopy (PSM) intensity level. A roughness of the surface is selected such that the surface produces scattered light for sufficient interference with the light scattered by the single molecules. The roughness of the surface is between 1 nm and 100 nm. The optically transparent substrate is coated with capture molecules that have a binding affinity for the single molecules. The capture molecules comprise one or more antibodies or binding portions thereof. The surface is coated with a metallic layer, and the incident angle is selected to create surface plasmon resonance on the metallic layer. The metallic layer is gold. The optically transparent substrate comprises an optical objective attached to a glass slide with index matching oil. The optically transparent substrate comprises an optical prism attached to a glass slide with index matching oil. The set of single molecules is label-free. The set of single molecules comprises one or more pharmaceutical candidate molecules. Performing the method steps in substantially real-time.

In another aspect, the present disclosure provides a system for detecting single-molecule binding kinetics. The system includes an optically transparent substrate; a fluid handler for flowing a set of single molecules over a surface of the substrate; a light source configured to irradiate the surface with light having an incident angle selected to achieve total reflection of the light; a camera; a collection optical system configured to collect light scatted by the surface and by at least a subset of single molecules having a binding association with the surface; and a controller operably connected at least to the fluid handler, the light source, the camera, and the collection optical system, which controller comprises a processor, and a memory communicatively coupled directly or remotely to the processor, the memory storing non-transitory computer executable instructions which, when executed by the processor, perform operations comprising: contacting the set of single molecules with the surface of the substrate using the fluid handler; irradiating the surface of the substrate with light having the incident angle selected to achieve total reflection of the light using the light source to thereby scatter light from the surface and from at least a subset of the single molecules having a binding association with the surface of the substrate; collecting light scattered by the surface and by the subset of the single molecules having the binding association with the surface of the substrate using the camera and the collection optical system to form a series of raw image data sets; and detecting multiple individual binding and leaving events for the subset of the single molecules having the binding association with the surface of the substrate over one or more selected durations using the series of raw image data sets to produce a detected individual binding and leaving event data set.

Various optional features of the above embodiments include the following. A roughness of the surface is selected such that the surface produces scattered light for sufficient interference with the light scattered by the target molecules. The roughness of the surface is between 1 nm and 100 nm. The collection optical system is configured to collect light scattered by the surface and by the subset of the single molecules having the binding association with the surface of the substrate from the opposite side of the incident and reflected light. The collection optical system is configured to collect light scatted by the surface and by the subset of the single molecules having the binding association with the surface of the substrate on the same side of the incident and reflected light, but avoid the collection of the reflected light. The solid substrate is coated with capture molecules that have a binding affinity for the single molecules. The capture molecules comprise one or more antibodies or binding portions thereof. The surface is coated with a metallic layer, and the incident angle is selected to create surface plasmon resonance on the metallic layer. The metallic layer is gold. The optically transparent solid substrate comprises an optical objective attached to a glass slide with index matching oil. The optically transparent solid substrate comprises an optical prism attached to a glass slide with index matching oil. The non-transitory computer executable instructions which, when executed by the processor, further perform operations comprising: determining one or more single molecule binding durations by pairing dynamic information in the detected individual binding and leaving event data set. The non-transitory computer executable instructions which, when executed by the processor, further perform operations comprising: determining at least one association rate (kₐ) and at least one dissociation rate (k_{d}) using the detected individual binding and leaving event data set. The non-transitory computer executable instructions which, when executed by the processor, further perform operations comprising: identifying specific binding events and non-specific binding events in the detected individual binding and leaving event data set. The non-transitory computer executable instructions which, when executed by the processor, further perform operations comprising: filtering identified non-specific binding events from the detected individual binding and leaving event data set. The non-transitory computer executable instructions which, when executed by the processor, further perform operations comprising: determining at least one association rate (kₐ) and at least one dissociation rate (k_{d}), and identifying specific binding events and non-specific binding events using the detected individual binding and leaving event data set in a single step. The non-transitory computer executable instructions which, when executed by the processor, further perform operations comprising: applying at least one data processing protocol to the series of raw image data sets to produce processed image data sets, which data processing protocol is configured to: remove noise from the series of raw image data sets; magnify one or more morphological characteristics of the single molecules in the series of raw image data sets; select one or more candidate pixels if an intensity level of a given candidate pixel in the series of raw image data sets exceeds a threshold intensity level to provide one or more sets of selected candidate pixels; extract location and intensity information for the single molecules in one or more selected regions that comprise the selected candidate pixels to provide a set of location and intensity information; and/or, identify the multiple individual binding and leaving events using the set of location and intensity information.

In yet another aspect, the present disclosure provides a computer readable media, comprising non-transitory computer executable instructions which, when executed by a processor, perform operations comprising: contacting a set of single molecules with a surface of a substrate using a fluid handler; irradiating the surface of the substrate with light having the incident angle selected to achieve total reflection of the light using a light source to thereby scatter light from the surface and from at least a subset of the single molecules having a binding association with the surface of the substrate; collecting light scattered by the surface and by the subset of the single molecules having the binding association with the surface of the substrate using a camera and a collection optical system to form a series of raw image data sets; and detecting multiple individual binding and leaving events for the subset of the single molecules having the binding association with the surface of the substrate over one or more selected durations using the series of raw image data sets to produce a detected individual binding and leaving event data set.

Various optional features of the above embodiments include the following. The non-transitory computer executable instructions which, when executed by the processor, further perform operations comprising: determining one or more single molecule binding durations by pairing dynamic information in the detected individual binding and leaving event data set. The non-transitory computer executable instructions which, when executed by the processor, further perform operations comprising: determining at least one association rate (kₐ) and at least one dissociation rate (k_{d}) using the detected individual binding and leaving event data set. The non-transitory computer executable instructions which, when executed by the processor, further perform operations comprising: identifying specific binding events and non-specific binding events in the detected individual binding and leaving event data set. The non-transitory computer executable instructions which, when executed by the processor, further perform operations comprising: determining at least one association rate (kₐ) and at least one dissociation rate (k_{d}), and identifying specific binding events and non-specific binding events using the detected individual binding and leaving event data set in a single step.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a flow chart that schematically shows exemplary method steps of detecting single-molecule binding kinetics according to some aspects disclosed herein.

FIG. 2 is a schematic optical setup for evanescent scattering microscopy (ESM) according to an exemplary embodiment.

FIG. 3 is a schematic optical setup for ESM according to an exemplary embodiment.

FIG. 4 is a schematic diagram of an exemplary system suitable for use with certain aspects disclosed herein.

FIG. 5 schematically depicts principles of detecting label-free single-molecule binding kinetics according to an exemplary embodiment.

FIG. 6 schematically shows certain steps performed by a single-molecule recognition algorithm according to an exemplary embodiment.

FIG. 7 schematically shows certain steps performed by a real-time specificity enhancement algorithm according to an exemplary embodiment.

FIGS. 8A-8C are plots that show the validation of the detection principle by IgA binding to anti-IgA. More specifically, FIGS. 8A-8C are the number of binding events (red) and their validated dissociation events overtime for 0.5 nm, 1 nm and 5 nm, respectively. The dots were fitted to the first order of kinetics (solid line).

FIG. 9 is a plot that shows the detection of bovine serum albumin (BSA).

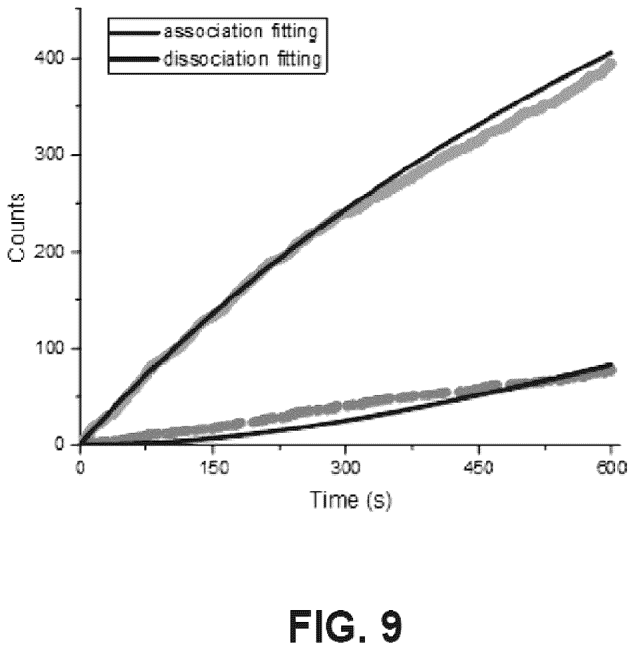

FIG. 10 schematically shows aspects of two proteins, having the same size, competing for the same binding ligand on a sensor surface according to an exemplary embodiment.

FIG. 11 schematically shows aspects of a procedure to study binding preference according to an exemplary embodiment.

### DEFINITIONS

In order for the present disclosure to be more readily understood, certain terms are first defined below. Additional definitions for the following terms and other terms may be set forth throughout the specification. If a definition of a term set forth below is inconsistent with a definition in an application or patent that is incorporated by reference, the definition set forth in this application should be used to understand the meaning of the term.

As used in this specification and the appended claims, the singular forms “a,” “an,” and “the” include plural references unless the context clearly dictates otherwise. Thus, for example, a reference to “a method” includes one or more methods, and/or steps of the type described herein and/or which will become apparent to those persons skilled in the art upon reading this disclosure and so forth.

It is also to be understood that the terminology used herein is for the purpose of describing particular embodiments only and is not intended to be limiting. Further, unless defined otherwise, all technical and scientific terms used herein have the same meaning as commonly understood by one of ordinary skill in the art to which this disclosure pertains. In describing and claiming the methods, systems, and computer readable media, the following terminology, and grammatical variants thereof, will be used in accordance with the definitions set forth below.

About: As used herein, “about” or “approximately” or “substantially” as applied to one or more values or elements of interest, refers to a value or element that is similar to a stated reference value or element. In certain embodiments, the term “about” or “approximately” or “substantially” refers to a range of values or elements that falls within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value or element unless otherwise stated or otherwise evident from the context (except where such number would exceed 100% of a possible value or element).

Antibody: As used herein, the term “antibody” refers to an immunoglobulin or an antigen-binding domain thereof. The term includes but is not limited to polyclonal, monoclonal, monospecific, polyspecific, non-specific, humanized, human, canonized, canine, felinized, feline, single-chain, chimeric, synthetic, recombinant, hybrid, mutated, grafted, and in vitro generated antibodies. The antibody can include a constant region, or a portion thereof, such as the kappa, lambda, alpha, gamma, delta, epsilon and mu constant region genes. For example, heavy chain constant regions of the various isotypes can be used, including: IgG₁, IgG₂, IgG₃, IgG₄, IgM, IgA₁, IgA₂, IgD, and IgE. By way of example, the light chain constant region can be kappa or lambda. The term “monoclonal antibody” refers to an antibody that displays a single binding specificity and affinity for a particular target, e.g., epitope.

Antigen Binding Portion: As used herein, the term “antigen binding portion” refers to a portion of an antibody that specifically binds to a given target protein, e.g., a molecule in which one or more immunoglobulin chains is not full length, but which specifically binds to the given target protein. Examples of binding portions encompassed within the term “antigen-binding portion of an antibody include (i) a Fab fragment, a monovalent fragment consisting of the VLC, VHC, CL and CHI domains: (ii) a F(ab′)2 fragment, a bivalent fragment comprising two Fab fragments linked by a disulfide bridge at the hinge region; (iii) a Fd fragment consisting of the VHC and CHI domains; (iv) a Fv fragment consisting of the VLC and VHC domains of a single arm of an antibody, (v) a dAb fragment, which consists of a VHC domain; and (vi) an isolated complementarity determining region (CDR) having sufficient framework to specifically bind, e.g., an antigen binding portion of a variable region. An antigen binding portion of a light chain variable region and an antigen binding portion of a heavy chain variable region, e.g., the two domains of the Fv fragment, VLC and VHC, can be joined, using recombinant methods, by a synthetic linker that enables them to be made as a single protein chain in which the VLC and VHC regions pair to form monovalent molecules (known as single chain Fv (scFV)). Such single chain antibodies are also encompassed within the term “antigen binding portion” of an antibody. The term “antigen binding portion” encompasses a single-domain antibody (sdAb), also known as a “nanobody” or “VHH antibody,” which is an antibody fragment consisting of a single monomeric variable antibody domain. These antibody portions are obtained using conventional techniques known to those with skill in the art, and the portions are screened for utility in the same manner as are intact antibodies.

Bind: As used herein, “bind” or “binding association” refers to a state in which a first chemical structure (e.g., a ligand) is sufficiently associated with a second chemical structure (e.g., a ligand receptor) such that the association between the first and second chemical structures can be detected. “Specific binding” is when, for example, a ligand binds substantially only to a receptor or other target molecule of interest, while “non-specific binding” is when a ligand binds to other sites.

Protein: As used herein, “protein” or “polypeptide” refers to a polymer of at least two amino acids attached to one another by a peptide bond. Examples of proteins include enzymes, hormones, antibodies, and fragments thereof.

Specifically Bind: As used herein, “specifically bind,” refers to a state in which substantially only target chemical structures (e.g., target ligand) are sufficiently associated with a corresponding or cognate binding agent (e.g., an antibody, or antigen binding portion thereof), to the exclusion of non-target chemical structures, such that the association between the target chemical structures and the binding agent can be detected.

### DETAILED DESCRIPTION

Molecular interactions are integral to virtually all biological processes in living systems, encompassing cell signaling, enzymatic reactions, protein functionality, and disease mechanisms. Understanding the kinetics of these interactions is crucial as it offers quantitative and mechanistic insights into the dynamic nature of molecular activities, essential for advancements in life sciences and biomedical applications. Over the years, numerous technologies have emerged for quantifying binding kinetics, including surface plasmon resonance (SPR), biolayer interferometry (BLI), and fluorescence spectroscopy. However, many of these methods are ensemble-based, providing averaged results from a multitude of molecules and overlooking the heterogeneity and diversity of individual molecules. Single-molecule techniques have been developed to address this limitation, broadly categorized into label-based and label-free approaches.

Label-based single-molecule technologies, such as kinetics fingerprinting and plasmonic imaging of nanoparticles, rely on labeling molecules with fluorescent probes, nanoparticles, or other tags for improved detection and visualization. While effective, the labeling process can potentially alter the properties of the molecules under investigation and may not be suitable for quantifying transient or low-affinity interactions. The inventors previously explored a label-free single-molecule method to eliminate these labeling effects. However, this method is still based on net counts, providing average results from bulk populations and lacking detailed information on individual binding events.

In some embodiments, this disclosure describes systems and methods for evanescent scattering microscopy (ESM), on plain glass surfaces with a total internal reflection (TIR) configuration by imaging the interference between the evanescent scattering light from the single molecules and from the natural roughness of the cover glass. An ESM system is calibrated with proteins of different molecular weights and used to analyze molecular binding kinetics and explore the heterogeneity of single protein behaviors during the molecular interaction process. Unlike other evanescent imaging systems, ESM provides high resolution images by reducing or eliminating parabolic tails, thus allowing precise tracking of nanoscale single molecule motions. This feature can be used to analyze diffusion properties of linker-anchored single protein molecules, which can be used for reagent-less biosensing, nano oscillators, and creating nanometer-scale spaces near the surface.

ESM allows the use of short incident wavelength for larger single molecule scattering cross section and high incident light intensity without significant heating effect, thus achieving ˜8 times lower detection limit than other plasmonic scattering imaging approaches. ESM can quantitatively analyze the heterogeneity of single molecule binding behaviors, providing an approach for understanding molecular interaction characteristics. In addition, ESM can be used to track the nanoscale motion of proteins anchored by molecular linkers to quantify the heterogeneity of linkers. This allows analysis of the heterogeneity of motion behaviors of proteins linked by chain molecules. The cover glass has no plasmonic quenching effect and good optical clearance, so the ESM can be integrated with fluorescence imaging for multiplexed detection.

ESM systems for single molecule imaging described herein are based on TIR, in some embodiments. ESM image contrast arises from the interference of evanescent light scattered by an analyte and the surface roughness as plasmonic scattering microscopy (PSM), which is different from other kinds of interference imaging methods using far field light. Using the tightly localized evanescent field to enhance the light-analyte interaction, ESM and PSM can achieve the same signal-to-noise ratio with either lower incident light power or wider field of view compared with nonevanescent approaches. Compared to PSM, ESM has at least two advantages. First, the incident wavelength is more flexible for the TIR configuration of ESM, while only the red or longer incident light can excite surface plasmonic resonance (SPR) at a gold-water interface. This makes it possible to employ 450 nm incident light for ESM to achieve ˜5 times larger scattering cross section than the PSM using red incident light, which can compensate the ˜6 times smaller intensity enhancement of evanescent wave created by TIR than the SPR. Second, ESM is constructed on the cover glass, which absorbs less light than gold film, thus allowing the incident light intensity of up to 60 kW cm⁻² without significant heating effect. This incident intensity is ˜30 times stronger than the PSM, making it possible for imaging single proteins with molecular weight down to ˜50 kDa.

ESM can quantify the protein binding kinetics by digitally counting the binding of individual molecules as PSM, thus offering similar advantages over ensemble SPR. ESM and PSM measurements are generally insensitive to the bulk refractive index changes, and allow analysis of the heterogeneity of protein behaviors for a deeper understanding of molecular interaction characteristics nearby the equilibrium state. Except for these mutual advantages, ESM can provide higher image contrast than PSM because |E_{b}|² is smaller on a cover glass than gold film coated cover glass, thus allowing tracking the nanoscale motion of chain molecule linked proteins for several potential applications. First, ESM allows tracking the diffusion behavior of antibody labelled nanoparticles with diameter smaller than 50 nm in complex media without a molecular crowding effect. Second, ESM can be used to quantify the heterogeneity of motion behaviors of proteins linked by chain molecules with different stiffness, which are commonly used biological complexes for reagent-less biosensing and nano oscillators, for designing labelling strategies with better homogeneity. In addition, tracking biological complex motion changes caused by binding of small target molecules may allow extending the ESM detection limit beyond the mass limitation of ˜19 kDa for the optical scattering measurement due at least in part to the phototoxicity and energy loss in the optical paths.

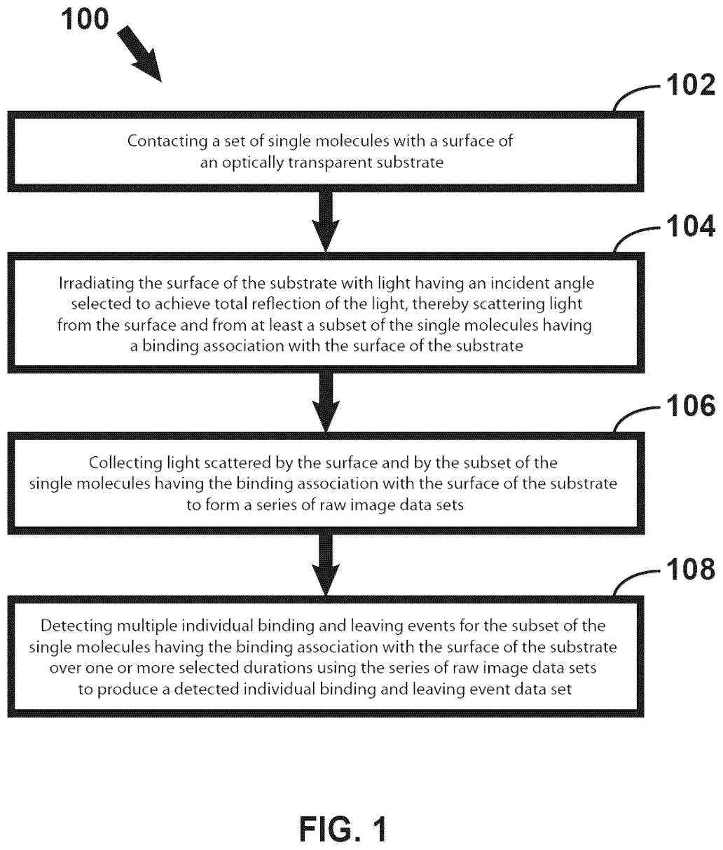

The present disclosure includes various methods of detecting single-molecule binding kinetics. To illustrate, FIG. 1 is a flow chart that schematically shows exemplary method steps of detecting single-molecule binding kinetics according to some aspects disclosed herein. As shown, method 100 includes contacting a set of single molecules with a surface of an optically transparent substrate (step 102). Method 100 also includes irradiating the surface of the substrate with light having an incident angle selected to achieve total reflection of the light, thereby scattering light from the surface and from at least a subset of the single molecules having a binding association with the surface of the substrate (step 104). Method 100 also includes collecting light scattered by the surface and by the subset of the single molecules having the binding association with the surface of the substrate to form a series of raw image data sets (step 106). In addition, method 100 also includes detecting multiple individual binding and leaving events for the subset of the single molecules having the binding association with the surface of the substrate over one or more selected durations using the series of raw image data sets to produce a detected individual binding and leaving event data set (step 108). Additional methods are described herein.

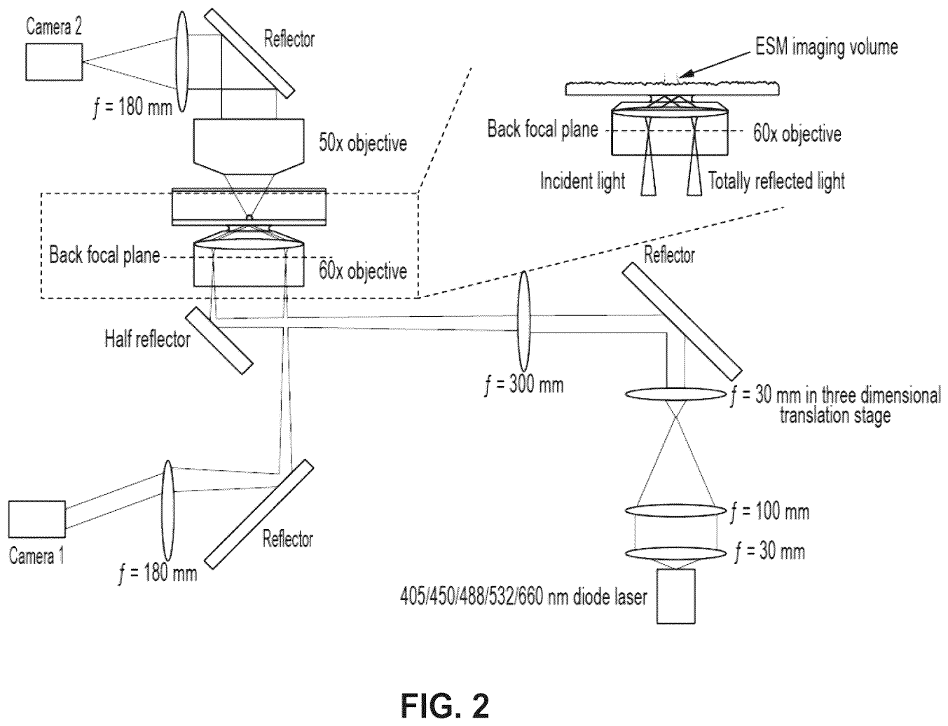

The methods and related systems disclosed herein utilize various optical setups. To illustrate one example, FIG. 2 is a schematic optical setup for evanescent scattering microscopy (ESM) according to an exemplary embodiment. As shown, light from the diode laser is conditioned and focused onto the back focal plane of a 60× objective (NA=1.49). Then the collimated laser beam was directed onto a cover glass mounted on the objective via refractive index match oil. Light reflected from the gold-coated glass slide is detected by camera 1 (MQ013MG-ON, XIMEA), which is equipped with an optical attenuator (ND30A, Thorlabs, Newton, NJ) to avoid overexposure. The reflection light is used to find the 60× objective focus. The incident light angle is adjusted to 65° using a three-dimensional translation stage (XR25P-K2, Thorlabs) to achieve total internal reflection (TIR). The incident light intensity is 60 kW cm-2 or less. Light scattered from the glass surface is collected by a 50× objective (NA=0.42) and detected by camera 2 (MQ003MG-CM, XIMEA) placed on top of the samples. A thin cover glass constructed flow cell constraining ˜50 μm channel height was employed for sample delivery (Nat Methods 17, 1010-1017 (2020)). An 80-mW laser diode (PL450B, Thorlabs, Newton, NJ, US) is used as the light source to provide the incident light with central wavelength at 450 nm for single protein imaging. Coherent OBIS FP 405 LX, OBIS FP 488LS, OBIS FP 532LS, and OBIS FP 660 LX lasers were used as the light source to provide the incident light with central wavelength at 405, 488, 532, and 660 nm to explore the effect of incident wavelength on image intensity.

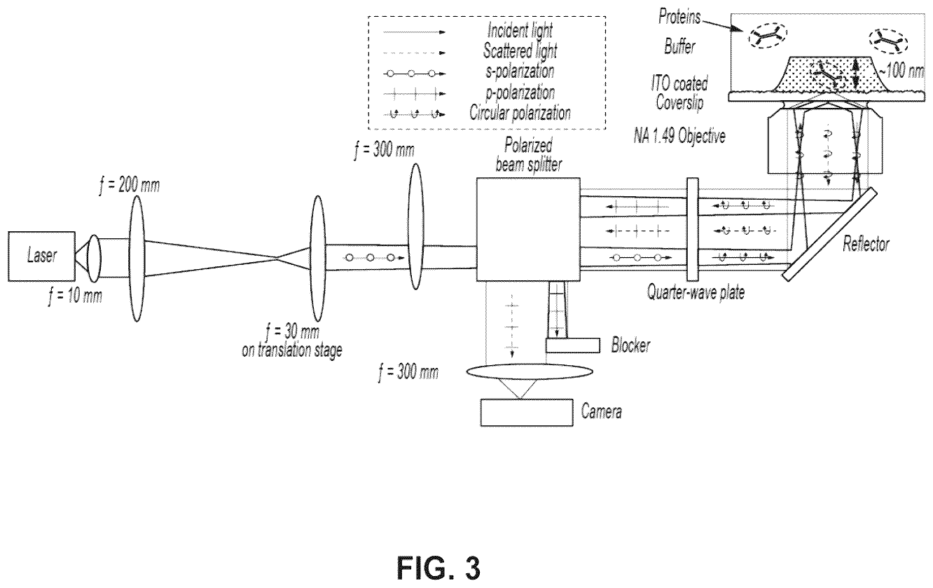

As a further illustration, FIG. 3 is a schematic optical setup for single-objective ESM according to another exemplary embodiment. As shown, light from a laser diode with a center wavelength of 660 nm (L660P120, Thorlabs, Newton, NJ, US) is firstly collimated by a lens group with effective focal length of 10 mm. The lens group is constructed by two achromatic doublet lenses with focal length of 19 mm. The laser diode is fixed at a temperature-controlled mount (LDM56, Thorlabs), which is driven by a benchtop diode current controller (LDC205C, Thorlabs) and a temperature controller (TED200C, Thorlabs). Then, the light is conditioned again by a lens group constructed by two achromatic doublet lenses with focal length of 200 mm and 30 mm, respectively. The lens with focal length of 30 mm is placed in a manual three-dimensional translation stage (XR25P-K2, Thorlabs) for adjusting the incident angle beyond the incident angle. Then, the light is focused to the back focal plane of a ×60 objective (Olympus APO N 60× Oil TIRF, NA 1.49) by a tube lens with focal length of 300 mm. A combination of polarization beam splitter with quarter-wave plate is employed to separate the signal light from incident light. Refection beams is blocked by a M4 screw with a diameter of 4 mm. The evanescent waves scattered by the ITO surface and proteins are collected by a camera (MQ003MG-CM, XIMEA).

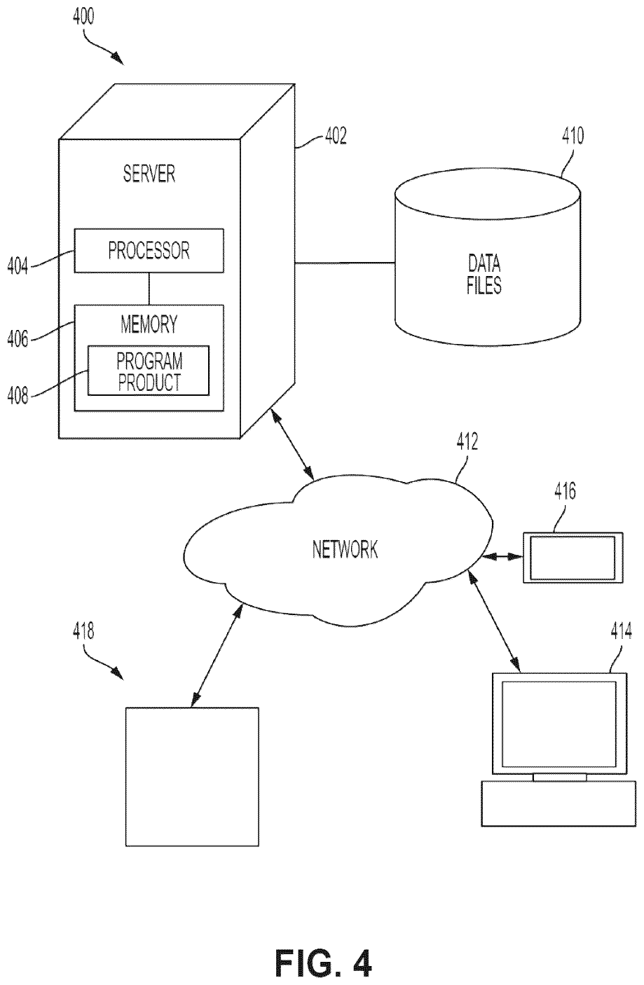

The present disclosure also provides various systems and computer program products or machine readable media. In some aspects, for example, the methods described herein are optionally performed or facilitated at least in part using systems, distributed computing hardware and applications (e.g., cloud computing services), electronic communication networks, communication interfaces, computer program products, machine readable media, electronic storage media, software (e.g., machine-executable code or logic instructions) and/or the like. To illustrate, FIG. 4 provides a schematic diagram of an exemplary system suitable for use with implementing at least aspects of the methods disclosed in this application. As shown, system 400 includes at least one controller or computer, e.g., server 402 (e.g., a search engine server), which includes processor 404 and memory, storage device, or memory component 406, and one or more other communication devices 414, 416, (e.g., client-side computer terminals, telephones, tablets, laptops, other mobile devices, etc. (e.g., for receiving data, etc.) in communication with the remote server 402, through electronic communication network 412, such as the Internet or other internetwork. Communication devices 414, 416 typically include an electronic display (e.g., an internet enabled computer or the like) in communication with, e.g., server 402 computer over network 412 in which the electronic display comprises a user interface (e.g., a graphical user interface (GUI), a web-based user interface, and/or the like) for displaying results upon implementing the methods described herein. In certain aspects, communication networks also encompass the physical transfer of data from one location to another, for example, using a hard drive, thumb drive, or other data storage mechanism. System 400 also includes program product 408 stored on a computer or machine readable medium, such as, for example, one or more of various types of memory, such as memory 406 of server 402, that is readable by the server 402, to facilitate, for example, a guided search application or other executable by one or more other communication devices, such as 414 (schematically shown as a desktop or personal computer). In some aspects, system 400 optionally also includes at least one database server, such as, for example, server 410 associated with an online website having data stored thereon searchable either directly or through search engine server 402. System 400 optionally also includes one or more other servers positioned remotely from server 402, each of which are optionally associated with one or more database servers 410 located remotely or located local to each of the other servers. The other servers can beneficially provide service to geographically remote users and enhance geographically distributed operations.

As understood by those of ordinary skill in the art, memory 406 of the server 402 optionally includes volatile and/or nonvolatile memory including, for example, RAM, ROM, and magnetic or optical disks, among others. It is also understood by those of ordinary skill in the art that although illustrated as a single server, the illustrated configuration of server 402 is given only by way of example and that other types of servers or computers configured according to various other methodologies or architectures can also be used. Server 402 shown schematically in FIG. 4, represents a server or server cluster or server farm and is not limited to any individual physical server. The server site may be deployed as a server farm or server cluster managed by a server hosting provider. The number of servers and their architecture and configuration may be increased based on usage, demand and capacity requirements for the system 400. As also understood by those of ordinary skill in the art, other user communication devices 414, 416 in these aspects, for example, can be a laptop, desktop, tablet, personal digital assistant (PDA), cell phone, server, or other types of computers. As known and understood by those of ordinary skill in the art, network 412 can include an internet, intranet, a telecommunication network, an extranet, or world wide web of a plurality of computers/servers in communication with one or more other computers through a communication network, and/or portions of a local or other area network.

As further understood by those of ordinary skill in the art, exemplary program product or machine readable medium 408 is optionally in the form of microcode, programs, cloud computing format, routines, and/or symbolic languages that provide one or more sets of ordered operations that control the functioning of the hardware and direct its operation. Program product 408, according to an exemplary aspect, also need not reside in its entirety in volatile memory, but can be selectively loaded, as necessary, according to various methodologies as known and understood by those of ordinary skill in the art.

As further understood by those of ordinary skill in the art, the term “computer-readable medium” or “machine-readable medium” refers to any medium that participates in providing instructions to a processor for execution. To illustrate, the term “computer-readable medium” or “machine-readable medium” encompasses distribution media, cloud computing formats, intermediate storage media, execution memory of a computer, and any other medium or device capable of storing program product 408 implementing the functionality or processes of various aspects of the present disclosure, for example, for reading by a computer. A “computer-readable medium” or “machine-readable medium” may take many forms, including but not limited to, non-volatile media, volatile media, and transmission media. Non-volatile media includes, for example, optical or magnetic disks. Volatile media includes dynamic memory, such as the main memory of a given system. Transmission media includes coaxial cables, copper wire and fiber optics, including the wires that comprise a bus. Transmission media can also take the form of acoustic or light waves, such as those generated during radio wave and infrared data communications, among others. Exemplary forms of computer-readable media include a floppy disk, a flexible disk, hard disk, magnetic tape, a flash drive, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave, or any other medium from which a computer can read.

Program product 408 is optionally copied from the computer-readable medium to a hard disk or a similar intermediate storage medium. When program product 408, or portions thereof, are to be run, it is optionally loaded from their distribution medium, their intermediate storage medium, or the like into the execution memory of one or more computers, configuring the computer(s) to act in accordance with the functionality or method of various aspects disclosed herein. All such operations are well known to those of ordinary skill in the art of, for example, computer systems. Typically, the detection of single molecules is obtained using device 418, which includes an optical setup for ESM as shown, for example, in FIG. 2 or 3, as exemplary embodiments.

### EXAMPLES

### Example 1: One-Step Label-Free Molecular Interaction Kinetic Measurement Based on Real-Time Detection of Single Molecule Binding Events

### Introduction

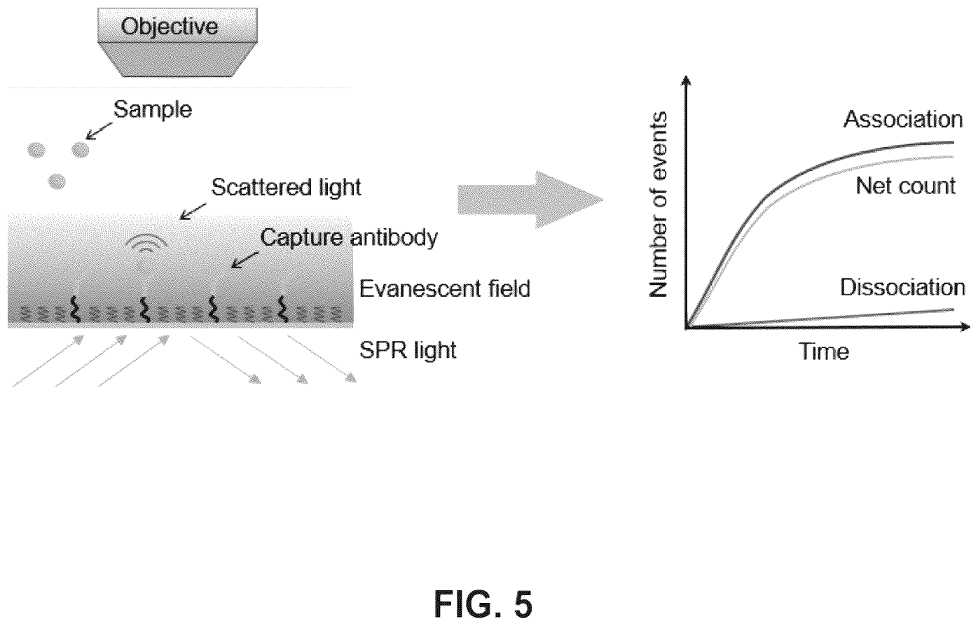

In this example, we introduce a novel label-free single-molecule technology capable of simultaneously capturing dynamic details of each individual analyte on a sensor surface in real-time. By leveraging kinetics-based information from each unique molecule binding or dissociating from the surface, we can differentiate between specific and nonspecific bindings. Analyzing the duration of each specific event allows us to determine association and dissociation rates in a single step, saving time compared to other techniques (FIG. 5). As a real-time counting-based technology, our method is particularly suited for studying weak or complex interactions, recording and analyzing all interactions at the single-molecular level on the sensor surface.

### Results

### Detection Principle

Incident light from a laser was collimated and directed onto the prism surface at a fixed angle to excite SPR. An inverted objective was placed on top of the gold film to collect the scattering light of molecules near the surface and the roughness of gold. Our Plasmonic Scattering Microscopy (PSM) imaging detects the interference between the scattered light from the molecules (Eₛ) and the surface roughness (E_{b}), given by the equation

$$\vert {E}_{b} + {E}_{s} {\vert}^{2} = \vert {E}_{b} {\vert}^{2} + \vert {E}_{s} {\vert}^{2} + 2 \vert {E}_{b} \vert \vert {E}_{s} \vert cos θ$$

where θ represents the phase difference. Since protein molecules typically have a diameter smaller than 30 nm, their scattering light is much less than the background reference light based on the principle of Rayleigh scattering. Therefore, the PSM intensity of analyte is linear with 2|E_{b}∥Eₛ|cos θ, which is in proportion to 3 times of analyte's diameter.

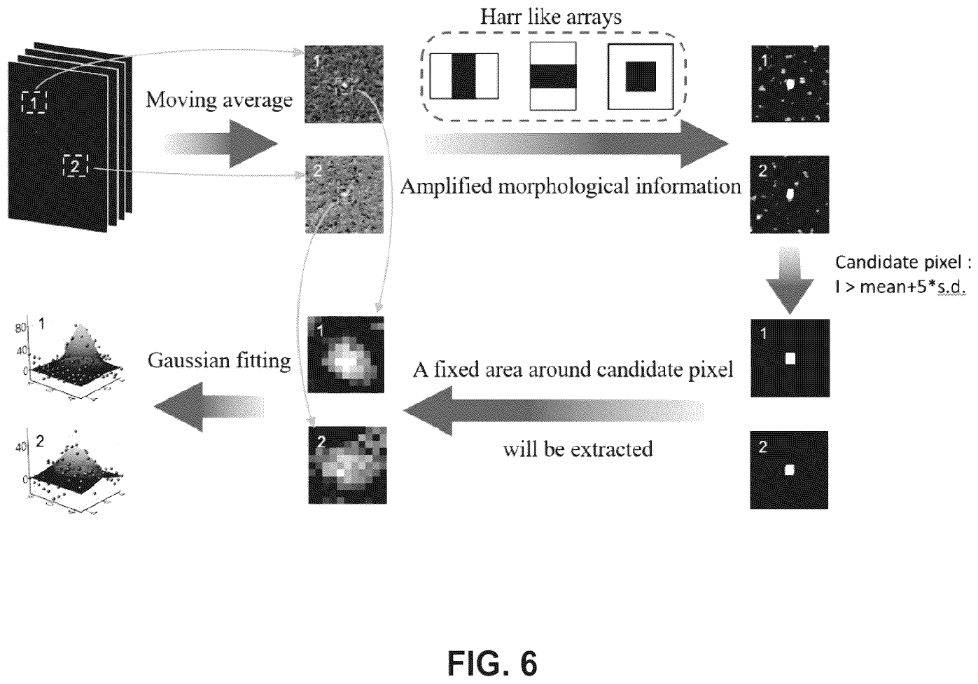

Single-molecule binding kinetics detection was achieved using an optimized data processing approach (FIG. 6). Raw images underwent row averaging and normalization to remove white noise and the influence from the unstable light source. Next, a Haar-like array was applied to magnify the morphological characteristics of the particles. Candidate pixels were selected if its intensity was higher than the mean+5×standard deviation (s.d.) of the whole processed imaged. Then, a 2D Gaussian model was fitted to the fixed region near the candidate pixels to extract the precise location and intensity of the particles. Candidate pixels with a significant bias in fitting from a Gaussian blob were deleted. Finally, the binding/leaving event of a single molecule appeared as a brightening/darkening Gaussian blob and gradually disappeared, with the maximum/minimum intensity in this process defining the molecule's PSM intensity.

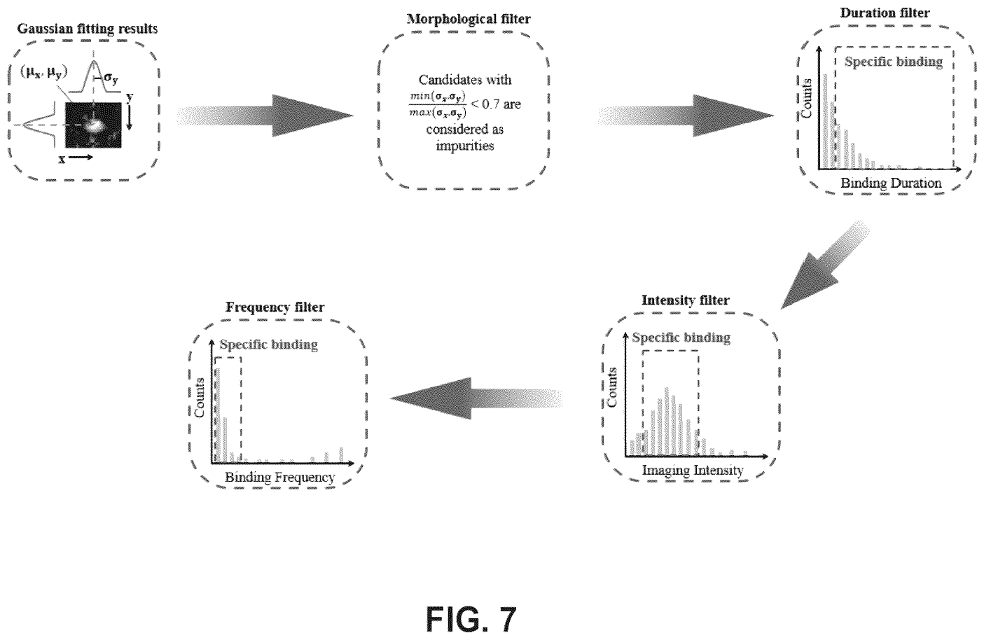

Having precise time, intensity, and location information for each individual binding/leaving event allows for the removal of most nonspecific bindings (FIG. 7). The duration of particles staying on the sensor surface can be determined by pairing the dynamic information of binding/leaving events. By fitting the total number of validated bindings and their corresponding leaving events to pseudo-first-order kinetics functions, the association rate (kₐ) and dissociation rate (k_{d}) can be determined using the equations:

$$\{ \begin{matrix}\frac{d [ Bind ]}{dt} = {k}_{a} \cdot [ L ] \cdot [ A ] \\ \frac{d [ Leave ]}{dt} = {k}_{d} \cdot [ L A ]\end{matrix} \qquad \begin{matrix}[ 1 ] \\ [ 2 ]\end{matrix}$$

where Bind is the number of validated binding events, Leave is the number of Bind's corresponding validated leaving events, L is the number of ligands on the sensor surface, A is the concentration of analyte in solution, LA is the number of complexes on sensor surface, kₐ and k_{d} are association and dissociation rate constant, respectively.

### Validation of Label-Free Single-Molecule Binding Kinetics by IgA/Anti-IgA Interaction

To demonstrate the effectiveness of our new method in measuring binding kinetics, we initially investigated the binding between IgA and anti-IgA, a well-studied interaction typically analyzed using traditional Surface Plasmon Resonance (SPR) techniques. To enhance the specificity of our approach, we first generated a calibration curve correlating Plasmonic Scattering Microscopy (PSM) intensity with the molecular weight of proteins. Based on the size of IgA, we established a threshold to eliminate nonspecific bindings caused by particles of varying mass.

In our experimental setup, anti-IgA was immobilized on the sensor surface, and solutions containing different concentrations of IgA were passed over the surface. By correlating the binding and leaving events, we identified leaving events occurring within a range of 3 pixels after the binding event and considered the corresponding PSM intensity of IgA as a validated event. The time gap between binding and validated leaving events represented the duration of the molecule's stay on the sensor.

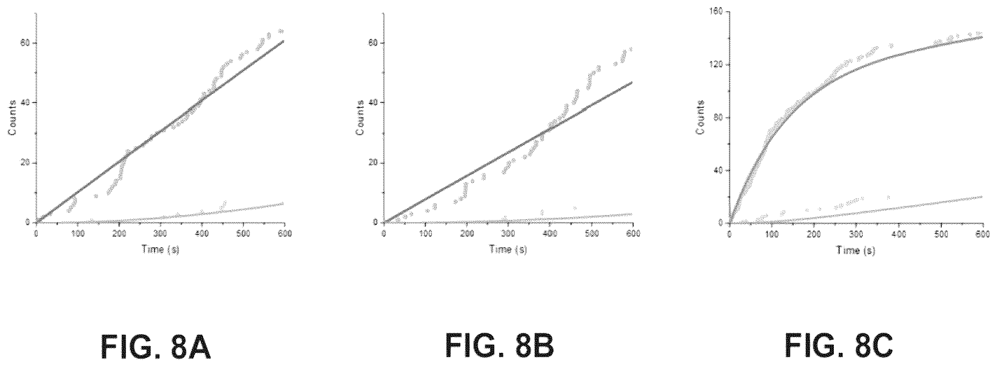

Through real-time counting and analysis of these events, we determined the total association events and their validated dissociation events. By fitting the curves into a mathematical model, we obtained the kinetics constants kₐ, k_{d} and K_{D} (equilibrium constant), which were calculated to be 2.65×10⁵ M⁻¹s⁻¹, 3.18×10⁻⁴ s⁻¹ and 1.20 nM, respectively (FIGS. 8A-8C). These values closely align with those reported in the literature, demonstrating that our new single-step method is suitable for real-time measurement of binding kinetics.

### Measurement of BSA Binding to Anti-BSA

To further demonstrate the high sensitivity of our label-free single-molecule technique, we studied the interaction between BSA and anti-BSA, whose diameter is only 10 nm. Anti-BSA was immobilized on the sensor surface and BSA with a concentration of 20 nM was flowed over the surface for 10 mins. After repeating the experiment 3 time, the kinetics constants kₐ, k_{d} and K_{D} can be determined to be 8.86×10⁴ M⁻¹s⁻¹, 6.95×10⁻⁴ s⁻¹ and 7.84 nM, respectively (FIG. 4), which is close to the value in the literature.

### Additional Advantages of Single Molecule Counting Based Binding Kinetic Measurement

Single molecule counting based measurement provides additional advantages over ensemble measurements. A few examples below:

### Measurement of Competitive Binding Kinetics

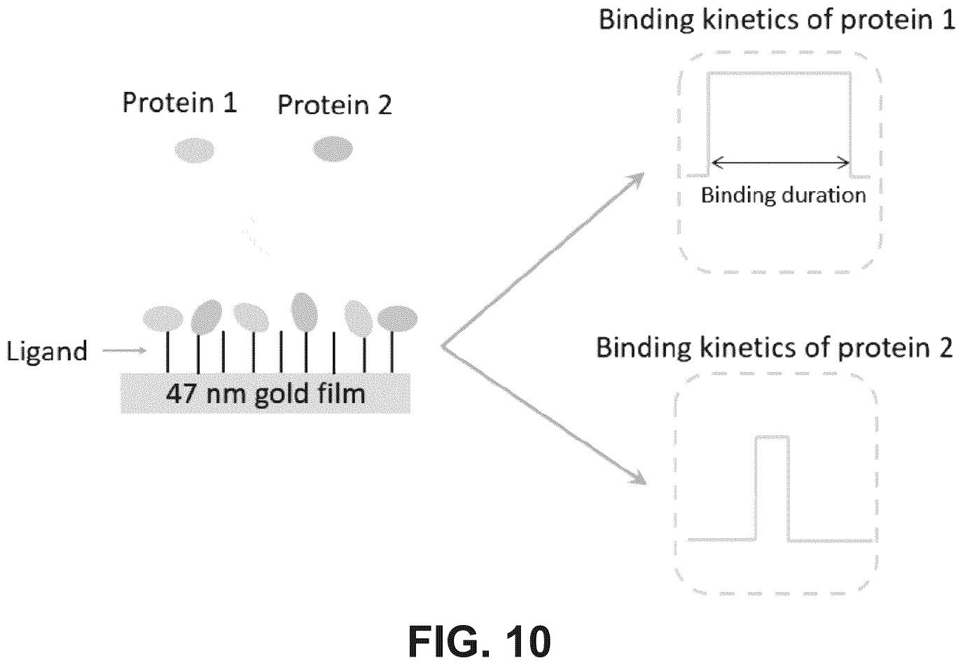

We can also determine the binding kinetics of mixed analytes to a ligand functionalized on the sensing surface.
Example 1: if a mixed analyte samples with 2 or more proteins of different sizes that both binding to the ligand functionalized on the sensor surface, different proteins can be identified by the binding signal intensity that scales with the protein size, and thus each proteins binding and leaving events can be counted separately and fitted with equation 1 and 2.
Example 2: if the mixed sample contains two proteins with the same mass but different affinities competing for the same ligand binding site (FIG. 10). The binding kinetics of both analytes can be fitted by the following equations:

$$\{ \begin{matrix}\frac{d [ A 1 ]}{d t} = {k}_{a 1} \times {b}_{1} \times [ L ] \times ( R - [ L A ] ) \\ \frac{d [ A 2 ]}{d t} = {k}_{a 2} \times {b}_{2} \times [ L ] \times ( R - [ L A ] ) \\ \frac{d [ D 1 ]}{d t} = {k}_{d 1} \times ( [ A 1 ] - [ D 1 ] ) \\ \frac{d [ D 2 ]}{d t} = {k}_{d 2} \times ( [ A 2 ] - [ D 2 ] ) \\ \frac{d [ L A ]}{d t} = \frac{d [ A 1 ]}{d t} + \frac{d [ A 2 ]}{d t} - \frac{d [ D 1 ]}{d t} - \frac{d [ D 2 ]}{d t}\end{matrix}$$

Since both proteins analyte has the same size, thus the same image intensity, the measured association and dissociation counts are [A]=[A1]+[A2], and [D]=[D1]+[D2], respectively. Where [A1], [A2], [D1], [D2] are the total association and dissociation counts of protein #1 and protein #2, while (kₐ₁, k_{d1}) and (kₐ₂, k_{d2}) are their corresponding kinetic constants. Additionally, b₁ and b₂ denote the ratio of the proteins in the solution.

After fitting the binding kinetics result, kinetic characters involved in the function can be determined.

### Measure of Binding Preference

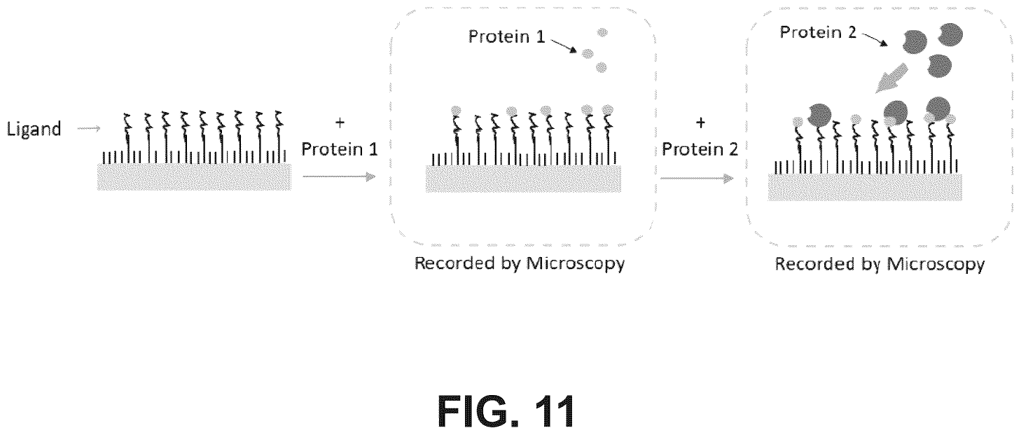

Fully using the location and time information of each single-molecule event, our technology can also study the binding preference of biomolecules. Take the two continuous experiments as an example, when protein 1 is binding to the ligand immobilized on the sensor surface, and protein 2 is binding to protein 1, or protein 2 is binding to the ligand with altered affinity due to the binding of protein 1. The locations of bound protein 1 are determined using the location information of protein 1's binding kinetics. Therefore, whether protein 2 prefers binding to protein 1's location can be determined by comparing the locations of bound protein 2 and protein 1. Protein 2 will prefer to bind to protein 1's location if protein 2 prefers to bind to protein 1, or protein 1's binding to the ligand can enhance the binding of protein 2 to the ligand, and vice versa (FIG. 11).

### Broader Application of the Method to Other Label-Free Single Molecule Detection Methods

Although we demonstrated our method with plasmonic scattering imaging, this method could be used with other label-free single molecule detection technologies, such as evanescent scattering microscopy and various implementations of interferometric scattering microscopy.

Some further aspects are defined in the following clauses:
Clause 1: A method of detecting single-molecule binding kinetics. The method comprising: contacting a set of single molecules with a surface of an optically transparent substrate; irradiating the surface of the substrate with light having an incident angle selected to achieve total reflection of the light, thereby scattering light from the surface and from at least a subset of the single molecules having a binding association with the surface of the substrate; collecting light scattered by the surface and by the subset of the single molecules having the binding association with the surface of the substrate to form a series of raw image data sets; and detecting multiple individual binding and leaving events for the subset of the single molecules having the binding association with the surface of the substrate over one or more selected durations using the series of raw image data sets to produce a detected individual binding and leaving event data set, thereby detecting the single-molecule binding kinetics.
Clause 2: The method of Clause 1, comprising determining one or more single molecule binding durations by pairing dynamic information in the detected individual binding and leaving event data set.
Clause 3: The method of Clause 1 or Clause 2, comprising determining at least one association rate (kₐ) and at least one dissociation rate (k_{d}) using the detected individual binding and leaving event data set.
Clause 4: The method of any one of the preceding Clauses 1-3, comprising identifying specific binding events and non-specific binding events in the detected individual binding and leaving event data set.
Clause 5: The method of any one of the preceding Clauses 1-4, comprising filtering identified non-specific binding events from the detected individual binding and leaving event data set.
Clause 6: The method of any one of the preceding Clauses 1-5, comprising determining at least one association rate (kₐ) and at least one dissociation rate (k_{d}), and identifying specific binding events and non-specific binding events using the detected individual binding and leaving event data set in a single step.
Clause 7: The method of any one of the preceding Clauses 1-6, comprising applying at least one data processing protocol to the series of raw image data sets to produce processed image data sets, which data processing protocol is configured to: remove noise from the series of raw image data sets; magnify one or more morphological characteristics of the single molecules in the series of raw image data sets; select one or more candidate pixels if an intensity level of a given candidate pixel in the series of raw image data sets exceeds a threshold intensity level to provide one or more sets of selected candidate pixels; extract location and intensity information for the single molecules in one or more selected regions that comprise the selected candidate pixels to provide a set of location and intensity information; and/or, identify the multiple individual binding and leaving events using the set of location and intensity information.
Clause 8: The method of any one of the preceding Clauses 1-7, comprising removing the noise by row averaging and normalizing the series of raw image data sets.
Clause 9: The method of any one of the preceding Clauses 1-8, comprising applying a Haar-like array to magnify the one or more morphological characteristics of the single molecules in the series of raw image data sets.
Clause 10: The method of any one of the preceding Clauses 1-9, comprising fitting a two-dimensional (2D) model to the one or more selected regions that comprise the selected candidate pixels to extract the set of location and intensity information.
Clause 11: The method of any one of the preceding Clauses 1-10, comprising deleting given candidate pixels in the sets of selected candidate pixels when the given candidate pixels have a bias level that exceeds a predetermined bias threshold level in fitting from at least one Gaussian blob.
Clause 12: The method of any one of the preceding Clauses 1-11, wherein the intensity level comprises a plasmonic scattering microscopy (PSM) intensity level.
Clause 13: The method of any one of the preceding Clauses 1-12, wherein a roughness of the surface is selected such that the surface produces scattered light for sufficient interference with the light scattered by the single molecules.
Clause 14: The method of any one of the preceding Clauses 1-13, wherein the roughness of the surface is between 1 nm and 100 nm.
Clause 15: The method of any one of the preceding Clauses 1-14, wherein the optically transparent substrate is coated with capture molecules that have a binding affinity for the single molecules.
Clause 16: The method of any one of the preceding Clauses 1-15, wherein the capture molecules comprise one or more antibodies or binding portions thereof.
Clause 17: The method of any one of the preceding Clauses 1-16, wherein the surface is coated with a metallic layer, and the incident angle is selected to create surface plasmon resonance on the metallic layer.
Clause 18: The method of any one of the preceding Clauses 1-17, wherein the metallic layer is gold.
Clause 19: The method of any one of the preceding Clauses 1-18, wherein the optically transparent substrate comprises an optical objective attached to a glass slide with index matching oil.
Clause 20: The method of any one of the preceding Clauses 1-19, wherein the optically transparent substrate comprises an optical prism attached to a glass slide with index matching oil.
Clause 21: The method of any one of the preceding Clauses 1-20, wherein the set of single molecules is label-free.
Clause 22: The method of any one of the preceding Clauses 1-21, wherein the set of single molecules comprises one or more pharmaceutical candidate molecules.
Clause 23: The method of any one of the preceding Clauses 1-22, comprising performing the method steps in substantially real-time.
Clause 24: A system for detecting single-molecule binding kinetics, the system comprising: an optically transparent substrate; a fluid handler for flowing a set of single molecules over a surface of the substrate; a light source configured to irradiate the surface with light having an incident angle selected to achieve total reflection of the light; a camera; a collection optical system configured to collect light scatted by the surface and by at least a subset of single molecules having a binding association with the surface; and a controller operably connected at least to the fluid handler, the light source, the camera, and the collection optical system, which controller comprises a processor, and a memory communicatively coupled directly or remotely to the processor, the memory storing non-transitory computer executable instructions which, when executed by the processor, perform operations comprising: contacting the set of single molecules with the surface of the substrate using the fluid handler; irradiating the surface of the substrate with light having the incident angle selected to achieve total reflection of the light using the light source to thereby scatter light from the surface and from at least a subset of the single molecules having a binding association with the surface of the substrate; collecting light scattered by the surface and by the subset of the single molecules having the binding association with the surface of the substrate using the camera and the collection optical system to form a series of raw image data sets; and detecting multiple individual binding and leaving events for the subset of the single molecules having the binding association with the surface of the substrate over one or more selected durations using the series of raw image data sets to produce a detected individual binding and leaving event data set.
Clause 25: The system of Clause 24, wherein a roughness of the surface is selected such that the surface produces scattered light for sufficient interference with the light scattered by the target molecules.
Clause 26: The system of Clause 24 or Clause 25, wherein the roughness of the surface is between 1 nm and 100 nm.
Clause 27: The system of any one of the preceding Clauses 24-26, wherein the collection optical system is configured to collect light scatted by the surface and by the subset of the single molecules having the binding association with the surface of the substrate from the opposite side of the incident and reflected light.
Clause 28: The system of any one of the preceding Clauses 24-27, wherein the collection optical system is configured to collect light scatted by the surface and by the subset of the single molecules having the binding association with the surface of the substrate on the same side of the incident and reflected light, but avoid the collection of the reflected light.
Clause 29: The system of any one of the preceding Clauses 24-28, wherein the solid substrate is coated with capture molecules that have a binding affinity for the single molecules.
Clause 30: The system of any one of the preceding Clauses 24-29, wherein the capture molecules comprise one or more antibodies or binding portions thereof.
Clause 31: The system of any one of the preceding Clauses 24-30, wherein the surface is coated with a metallic layer, and the incident angle is selected to create surface plasmon resonance on the metallic layer.
Clause 32: The system of any one of the preceding Clauses 24-31, wherein the metallic layer is gold.
Clause 33: The system of any one of the preceding Clauses 24-32, wherein the optically transparent solid substrate comprises an optical objective attached to a glass slide with index matching oil.
Clause 34: The system of any one of the preceding Clauses 24-33, wherein the optically transparent solid substrate comprises an optical prism attached to a glass slide with index matching oil.
Clause 35: The system of any one of the preceding Clauses 24-34, wherein the non-transitory computer executable instructions which, when executed by the processor, further perform operations comprising: determining one or more single molecule binding durations by pairing dynamic information in the detected individual binding and leaving event data set.
Clause 36: The system of any one of the preceding Clauses 24-35, wherein the non-transitory computer executable instructions which, when executed by the processor, further perform operations comprising: determining at least one association rate (kₐ) and at least one dissociation rate (k_{d}) using the detected individual binding and leaving event data set.
Clause 37: The system of any one of the preceding Clauses 24-36, wherein the non-transitory computer executable instructions which, when executed by the processor, further perform operations comprising: identifying specific binding events and non-specific binding events in the detected individual binding and leaving event data set.
Clause 38: The system of any one of the preceding Clauses 24-37, wherein the non-transitory computer executable instructions which, when executed by the processor, further perform operations comprising: filtering identified non-specific binding events from the detected individual binding and leaving event data set.
Clause 39: The system of any one of the preceding Clauses 24-38, wherein the non-transitory computer executable instructions which, when executed by the processor, further perform operations comprising: determining at least one association rate (kₐ) and at least one dissociation rate (k_{d}), and identifying specific binding events and non-specific binding events using the detected individual binding and leaving event data set in a single step.
Clause 40: The system of any one of the preceding Clauses 24-39, wherein the non-transitory computer executable instructions which, when executed by the processor, further perform operations comprising: applying at least one data processing protocol to the series of raw image data sets to produce processed image data sets, which data processing protocol is configured to: remove noise from the series of raw image data sets; magnify one or more morphological characteristics of the single molecules in the series of raw image data sets; select one or more candidate pixels if an intensity level of a given candidate pixel in the series of raw image data sets exceeds a threshold intensity level to provide one or more sets of selected candidate pixels; extract location and intensity information for the single molecules in one or more selected regions that comprise the selected candidate pixels to provide a set of location and intensity information; and/or, identify the multiple individual binding and leaving events using the set of location and intensity information.
Clause 41: A computer readable media, comprising non-transitory computer executable instructions which, when executed by a processor, perform operations comprising: contacting a set of single molecules with a surface of a substrate using a fluid handler; irradiating the surface of the substrate with light having the incident angle selected to achieve total reflection of the light using a light source to thereby scatter light from the surface and from at least a subset of the single molecules having a binding association with the surface of the substrate; collecting light scattered by the surface and by the subset of the single molecules having the binding association with the surface of the substrate using a camera and a collection optical system to form a series of raw image data sets; and detecting multiple individual binding and leaving events for the subset of the single molecules having the binding association with the surface of the substrate over one or more selected durations using the series of raw image data sets to produce a detected individual binding and leaving event data set.
Clause 42: The computer readable media of Clause 41, wherein the non-transitory computer executable instructions which, when executed by the processor, further perform operations comprising: determining one or more single molecule binding durations by pairing dynamic information in the detected individual binding and leaving event data set.
Clause 43: The computer readable media of Clause 41 or Clause 42, wherein the non-transitory computer executable instructions which, when executed by the processor, further perform operations comprising: determining at least one association rate (kₐ) and at least one dissociation rate (k_{d}) using the detected individual binding and leaving event data set.
Clause 44: The computer readable media of any one of the preceding Clauses 41-43, wherein the non-transitory computer executable instructions which, when executed by the processor, further perform operations comprising: identifying specific binding events and non-specific binding events in the detected individual binding and leaving event data set.
Clause 45: The computer readable media of any one of the preceding Clauses 41-44, wherein the non-transitory computer executable instructions which, when executed by the processor, further perform operations comprising: determining at least one association rate (kₐ) and at least one dissociation rate (k_{d}), and identifying specific binding events and non-specific binding events using the detected individual binding and leaving event data set in a single step.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of detecting single-molecule binding kinetics, the method comprising:
contacting a set of single molecules with a surface of an optically transparent substrate;
irradiating the surface of the substrate with light having an incident angle selected to achieve total reflection of the light, thereby scattering light from the surface and from at least a subset of the single molecules having a binding association with the surface of the substrate;
collecting light scattered by the surface and by the subset of the single molecules having the binding association with the surface of the substrate to form a series of raw image data sets; and,
detecting multiple individual binding and leaving events for the subset of the single molecules having the binding association with the surface of the substrate over one or more selected durations using the series of raw image data sets to produce a detected individual binding and leaving event data set, thereby detecting the single-molecule binding kinetics.

2. The method of claim 1, comprising determining one or more single molecule binding durations by pairing dynamic information in the detected individual binding and leaving event data set.

3. The method of claim 1, comprising determining at least one association rate (kₐ) and at least one dissociation rate (k_{d}) using the detected individual binding and leaving event data set.

4. The method of claim 1, comprising identifying specific binding events and non-specific binding events in the detected individual binding and leaving event data set.

5. The method of claim 4, comprising filtering identified non-specific binding events from the detected individual binding and leaving event data set.

6. The method of claim 1, comprising determining at least one association rate (kₐ) and at least one dissociation rate (k_{d}), and identifying specific binding events and non-specific binding events using the detected individual binding and leaving event data set in a single step.

7. The method of claim 1, comprising applying at least one data processing protocol to the series of raw image data sets to produce processed image data sets, which data processing protocol is configured to:
remove noise from the series of raw image data sets;
magnify one or more morphological characteristics of the single molecules in the series of raw image data sets;
select one or more candidate pixels if an intensity level of a given candidate pixel in the series of raw image data sets exceeds a threshold intensity level to provide one or more sets of selected candidate pixels;
extract location and intensity information for the single molecules in one or more selected regions that comprise the selected candidate pixels to provide a set of location and intensity information; and/or,
identify the multiple individual binding and leaving events using the set of location and intensity information.

8. The method of claim 7, comprising removing the noise by row averaging and normalizing the series of raw image data sets.

9. The method of claim 7, comprising applying a Haar-like array to magnify the one or more morphological characteristics of the single molecules in the series of raw image data sets.

10. The method of claim 7, comprising fitting a two-dimensional (2D) model to the one or more selected regions that comprise the selected candidate pixels to extract the set of location and intensity information.

11. The method of claim 7, comprising deleting given candidate pixels in the sets of selected candidate pixels when the given candidate pixels have a bias level that exceeds a predetermined bias threshold level in fitting from at least one Gaussian blob.

12. A system for detecting single-molecule binding kinetics, the system comprising:
an optically transparent substrate;
a fluid handler for flowing a set of single molecules over a surface of the substrate;
a light source configured to irradiate the surface with light having an incident angle selected to achieve total reflection of the light;
a camera;
a collection optical system configured to collect light scatted by the surface and by at least a subset of single molecules having a binding association with the surface; and
a controller operably connected at least to the fluid handler, the light source, the camera, and the collection optical system, which controller comprises a processor, and a memory communicatively coupled directly or remotely to the processor, the memory storing non-transitory computer executable instructions which, when executed by the processor, perform operations comprising:
contacting the set of single molecules with the surface of the substrate using the fluid handler;
irradiating the surface of the substrate with light having the incident angle selected to achieve total reflection of the light using the light source to thereby scatter light from the surface and from at least a subset of the single molecules having a binding association with the surface of the substrate;
collecting light scattered by the surface and by the subset of the single molecules having the binding association with the surface of the substrate using the camera and the collection optical system to form a series of raw image data sets; and
detecting multiple individual binding and leaving events for the subset of the single molecules having the binding association with the surface of the substrate over one or more selected durations using the series of raw image data sets to produce a detected individual binding and leaving event data set.

13. The system of claim 12, wherein the collection optical system is configured to collect light scatted by the surface and by the subset of the single molecules having the binding association with the surface of the substrate from the opposite side of the incident and reflected light.

14. The system of claim 12, wherein the collection optical system is configured to collect light scatted by the surface and by the subset of the single molecules having the binding association with the surface of the substrate on the same side of the incident and reflected light, but avoid the collection of the reflected light.

15. The system of claim 12, wherein the non-transitory computer executable instructions which, when executed by the processor, further perform operations comprising:
determining one or more single molecule binding durations by pairing dynamic information in the detected individual binding and leaving event data set.

16. The system of claim 12, wherein the non-transitory computer executable instructions which, when executed by the processor, further perform operations comprising:
determining at least one association rate (kₐ) and at least one dissociation rate (k_{d}) using the detected individual binding and leaving event data set.

17. The system of claim 12, wherein the non-transitory computer executable instructions which, when executed by the processor, further perform operations comprising:
identifying specific binding events and non-specific binding events in the detected individual binding and leaving event data set.

18. The system of claim 12, wherein the non-transitory computer executable instructions which, when executed by the processor, further perform operations comprising:
determining at least one association rate (kₐ) and at least one dissociation rate (k_{d}), and identifying specific binding events and non-specific binding events using the detected individual binding and leaving event data set in a single step.

19. The system of claim 12, wherein the non-transitory computer executable instructions which, when executed by the processor, further perform operations comprising:
applying at least one data processing protocol to the series of raw image data sets to produce processed image data sets, which data processing protocol is configured to:
remove noise from the series of raw image data sets;
magnify one or more morphological characteristics of the single molecules in the series of raw image data sets;
select one or more candidate pixels if an intensity level of a given candidate pixel in the series of raw image data sets exceeds a threshold intensity level to provide one or more sets of selected candidate pixels;
extract location and intensity information for the single molecules in one or more selected regions that comprise the selected candidate pixels to provide a set of location and intensity information; and/or,
identify the multiple individual binding and leaving events using the set of location and intensity information.

20. A computer readable media, comprising non-transitory computer executable instructions which, when executed by a processor, perform operations comprising:
contacting a set of single molecules with a surface of a substrate using a fluid handler;
irradiating the surface of the substrate with light having the incident angle selected to achieve total reflection of the light using a light source to thereby scatter light from the surface and from at least a subset of the single molecules having a binding association with the surface of the substrate;
collecting light scattered by the surface and by the subset of the single molecules having the binding association with the surface of the substrate using a camera and a collection optical system to form a series of raw image data sets; and
detecting multiple individual binding and leaving events for the subset of the single molecules having the binding association with the surface of the substrate over one or more selected durations using the series of raw image data sets to produce a detected individual binding and leaving event data set.
